(19) United States
(12) Patent Application Publication
(10) Pub. No.: US 2025/0371332 A1
(43) Pub. Date: Dec. 4, 2025

(54) THREE-DIMENSIONAL PROGRAMMABLE NEURAL NETWORKS

(71) Applicant: California Institute of Technology, Pasadena, CA (US)

(72) Inventors: Baris Volkan Gurses, Pasadena, CA (US); Seyed Ali Hajimiri, La Canada, CA (US)

(21) Appl. No.: 19/283,189

(22) Filed: Jul. 28, 2025

Related U.S. Application Data
(60) Provisional application No. 63/652,541, filed on May 28, 2024.

(51) Int. Cl. G06N 3/067

(52) U.S. Cl. CPC G06N 3/0675

(57) ABSTRACT

An optical neural network includes a multitude of N-element layers each of which includes a multitude of N-element sublayers, wherein N is an integer greater than or equal to 2. Each sublayer i of layer j of the neural network includes an optical transceiver, which in turn includes, in part, N first optical amplitude modulators each adapted to modulate an amplitude of an optical signal S^{k}_{i,j}, wherein k is an index identifying the element number ranging from 1 to N. The transceiver further includes, in part, N first optical phase modulators each adapted to modulate a phase of an amplitude-modulated signal supplied by an associated one of the N first optical amplitude modulators. The amount of modulations selected to be performed by the N first amplitude modulator and the N first phase modulators represent values of a first matrix by which the optical signal matrix S^{k}_{i,j} is multiplied.

### RELATED APPLICATIONS

The present application claims benefit under 35 U.S.C. § 119 to U.S. Provisional Application No. 63/813,806, filed on May 29, 2025, the content of which is incorporated herein by reference in its entirety.

### TECHNICAL FIELD

The present application relates to a three-dimensional neural network, and more particularly to an optical or an opto-electronic three-dimensional neural network.

### BACKGROUND

Silicon photonics is an emerging technology with the potential for overcoming the power consumption and bandwidth limitations of conventional electronics. Machine learning is one area in which silicon photonic integrated circuits can be used to realize deep neural networks. The existing implementations of on-chip neural networks while providing improvements in bandwidth and power consumption, lack the connectivity and the routing capability that would be required to realize dense networks with M×N connections to connect a layer with M neurons to a layer with N neurons.

### SUMMARY

An optical neural network, in accordance with one embodiment of the present disclosure includes a multitude of N-element layers each of which includes a multitude of N-element sublayers, wherein N is an integer greater than or equal to 2. Each sublayer i of layer j of the neural network includes an optical transceiver, which in turn includes, in part, N first optical amplitude modulators each adapted to modulate an amplitude of an optical signal S^{k}_{i,j}, wherein k is an index identifying the element number ranging from 1 to N. The transceiver further includes, in part, N first optical phase modulators each adapted to modulate a phase of an amplitude-modulated signal supplied by an associated one of the N first optical amplitude modulators. The amount of modulations selected to be performed by the N first amplitude modulator and the N first phase modulators represent values of a first matrix by which the optical signal matrix S^{k}_{i,j} is multiplied.

The optical transceiver further includes, in part, N optical transmit antennas each adapted to radiate the phase-modulated signal supplied by an associated one of the N first phase optical modulators; and N optical receivers each adapted to receive the optical signal radiated by an associated one of the N optical transmit antennas, wherein the diffractions provided by the diffractive clock represent a square circulant matrix.

The transceiver further includes N second optical phase modulators each adapted to modulate a phase of an optical signal received by an associated one of the N optical receive antennas, and N second optical amplitude modulators each adapted to modulate an amplitude of a phase-modulated signal supplied by an associated one of the N second phase modulators. The modulations selected to be performed by the N second amplitude modulator and N second phase modulators represent values of a second matrix by which the circulant matrix is multiplied.

In one embodiment, the optical neural network further includes, in part, an input optical receiver that includes, in part, N optical antennas each receiving a light emitted by a coherent source of light and delivering the received light to the N first optical amplitude modulators of the first sublayer of the first layer of the neural network. In one embodiment, the optical neural network further includes, in part, an N-element non-linear optical component adapted to receive and set values of each of the N second optical amplitude-modulated signals that are below a threshold value to zero.

In one embodiment, the neural network, further includes, in part, a second optical transceiver associated with the sublayer (i+1) of the layer j of the neural network. The second optical transceiver is cascaded with the optical transceiver of the sublayer i of the layer j of the neural network. In one embodiment, the optical neural network further includes, in part, N optical-to-electrical signal converters each associated with and coupled to a different one of N outputs of the non-linear optical component to convert the optical signal supplied at the associated output to an electrical signal.

An opto-electronic neural network, in accordance with one embodiment of the present disclosure, includes, in part, a multitude of N-element layers each of which includes a multitude of N-element sublayers. Sublayer i of layer j of the neural network includes, in part, N first amplitude modulators each adapted to modulate an amplitude of an optical signal received from a power splitter via a first associated electrical signal; N first phase modulators each associated with a different one of the N first amplitude modulators and adapted to modulate a phase of an optical signal received from the associated amplitude modulator via a second associated electrical signal; and a transceiver.

The transceiver includes, in part, N first optical amplitude modulators each adapted to modulate an amplitude of an optical signal S^{k}_{i,j} received from an associated one of the N first phase modulators, wherein k is an index identifying the element number ranging from 1 to N. The transceiver further includes, in part, N first optical phase modulators each adapted to modulate a phase of an amplitude-modulated signal supplied by an associated one of the N first optical amplitude modulators. The amount of modulations selected to be performed by the N first amplitude modulator and the N first phase modulators represent values of a first matrix by which the optical signal matrix is S^{k}_{i,j}. The opto-electronic neural network further includes, in part, a diffractive block, which in turn includes, in part, N optical radiators each adapted to radiate the phase-modulated signal supplied by an associated one of the N first phase optical modulators; and N optical receivers each adapted to receive the optical signal radiated by an associated one of the N radiators. The diffractions provided by the diffractive block represent a square circulant matrix. The opto-electronic neural network further includes, in part, N second optical phase modulators each adapted to modulate a phase of an optical signal received by an associated one of the N receivers; and N second optical amplitude modulators each adapted to modulate an amplitude of a phase-modulated signal supplied by an associated one of the N second phase modulators. The modulations selected to be performed by the N second amplitude modulator and N second phase modulators represent values of a second matrix by which the circulant matrix is multiplied.

In one embodiment, the opto-electronic neural network further includes, in part, N in-phase (I) and N quadrature-phase (Q) detectors. Each I/Q detector is adapted to convert, using an optical local oscillator signal, an output signal of a different one of the N second optical amplitude modulators to an I signal and a Q signal. The opto-electronic neural network further includes 2N optical-to-electrical signal converters each associated with and adapted to convert a different one of N I signals and N Q signals to an electrical signal.

In one embodiment, the opto-electronic neural network further includes, in part, an optical conversion unit (OCU), which includes, in part, a first N signal processing blocks each associated with a different one of the N I electrical signals; and a second N signal processing blocks each associated with a different one of the N Q electrical signals, wherein the first N signal processing blocks and the second N processing blocks associated with the same element k are adapted to generate signals U^{k}_{i,j} and V^{k}_{i,j} representative of the magnitude and phase of the signals I^{k}_{i,j} and Q^{k}_{i,j} received by the element k.

In one embodiment, the opto-electronic neural network further includes, in part, N first variable gain amplifiers each adapted to amplify an associated U^{k}_{i,j} signals; and N second variable gain amplifiers each adapted to amplify an associated V^{k}_{i,j} signals. In one embodiment, the opto-electronic neural network further includes, in part, N first switches and N second switches that are closed to supply the amplified U^{k}_{i,j} signal and V^{k}_{i,j} signals as output signals of the OCU if sublayer i is not the last sublayer of layer j. The opto-electronic neural network further includes, in part, N third switches and N fourth switches that are closed to cause signal U^{k}_{i,j} to be added to signal U^{k}_{i-1,j} if sublayer i is the last sublayer of layer j. The opto-electronic neural network further includes, in part, a non-linear optical component adapted to receive a result of adding signals U^{k}_{i,j} and V^{k}_{i,j} and set values of each of the received signals that are below a threshold value to zero.

In one embodiment, the opto-electronic neural network further includes, in part, a second transceiver associated with the sublayer (i+1) of the layer j of the neural network, wherein the second transceiver is cascaded with the transceiver of the sublayer i of the layer j of the opto-electronic neural network.

A method of forming an optical neural network that include in part a multitude of N-element layers each including a multitude of N-element sublayers, in accordance with one embodiment of the present disclosure, includes, in part, modulating an amplitude of each of N first optical signal S^{k}_{i,j} by first N amplitude modulators, wherein k is an index representing the element number ranging from 1 to N, i represents a sublayer number, and j represents a layer number of the optical neural network. The method further includes, in part, modulating a phase of each of the N first amplitude modulated optical signals by first N phase modulators, wherein an amount of modulations selected for the first N amplitude modulations and the first N phase modulations represent values of a first matrix by which the optical signal matrix S^{k}_{i,j} is multiplied. The method further includes, in part, radiating each of the N amplitude modulated and phase-modulated optical signals via a diffraction block; receiving each of the N radiated signals by an associated one of N receivers of the diffractive block, wherein diffractions provided by the diffractive block represent a square circulant matrix. The method further includes, in part, modulating a phase of each of the second N optical signals received by the N receivers of the diffractive block using N second phase modulators; and modulating an amplitude of each of the N second phase-modulated signals using N second amplitude modulators. The amount of modulations selected to be performed by the N second amplitude modulations and the N second phase modulations represent values of a second matrix by which the circulant matrix is multiplied.

In one embodiment, the method further includes, in part, receiving a light emitted by a coherent source of light; and delivering the received light to the N first optical amplitude modulators of the first sublayer of the first layer of the neural network. In one embodiment, the method further includes, in part, setting values of each of the second N modulated signals that are below a threshold value to zero by a non-linear optical component. In one embodiment of the method, the first N amplitude modulators, the first N phase modulators, the diffractive block, the second N phase modulators, and the second N amplitude modulators form a first optical transceiver of sublayer i of layer j of the neural network; in such embodiments, the method further includes, in part, cascading the first transceiver with a second optical transceiver associated with the sublayer (i+1) of the layer j of the neural network. In one embodiment, the method further includes, in part, converting an optical signal supplied at each of the N outputs of the non-linear optical component to an electrical signal.

A method of forming an opto-electronic neural network that includes in part a multitude of N-element layers each including a multitude of N-element sublayers, in accordance with one embodiment of the present disclosure, includes, in part, modulating, via N first amplitude modulators, an amplitude of each of N optical signals received from a power splitter using a first associated electrical signal; modulating, via N first phase modulators, a phase of each of the N amplitude modulated optical signals using a second associated electrical signal; modulating an amplitude of each of N first optical signals S^{k}_{i,j} received from an associated one of the N first phase modulators, by N first optical amplitude modulators wherein k is an index representing the element number ranging from 1 to N, i represents a sublayer number, and j represents a layer number of the optical neural network; modulating a phase of each of the N first amplitude modulated optical signals by first N phase modulators, wherein an amount of modulations selected for the first N amplitude modulations and the first N phase modulations represent values of a first matrix by which the optical signal matrix S^{k}_{i,j} is multiplied; radiating each of the N amplitude modulated and phase-modulated optical signals via a diffractive block; receiving each of the N radiated signals by an associated one N receivers of the diffractive block, wherein diffractions provided by diffractive block represents a square circulant matrix; modulating a phase of each of the second N optical signals received by the N receivers of the diffractive block using N second phase modulators; and modulating an amplitude of each of the N second phase-modulated signals using N second amplitude modulators, wherein an amount of modulations selected to be performed by the N second amplitude modulations and the N second phase modulations represent values of a second matrix by which the circulant matrix is multiplied.

In one embodiment, the method further includes, in part, converting, using an optical local oscillator signal, an output signal of each of the N second optical amplitude modulators to an I signal and a Q signal; converting each of the N I signals to a corresponding electrical signal; and converting each of the N Q signals to a corresponding electrical signal. In one embodiment, the method further includes, in part, generating signals U^{k}_{i,j} and V^{k}_{i,j} representative of magnitudes and phase of the signals I^{k}_{i,j} and Q^{k}_{i,j}. In one embodiment, the method further includes, in part, amplifying each of the U^{k}_{i,j} signals; and amplifying each of the V^{k}_{i,j} signals.

In one embodiment, the method further includes, in part, closing N first switches and N second switches in order to supply the amplified U^{k}_{i,j} signals and V^{k}_{i,j} signals as output signals if sublayer i is not the last sublayer of layer j; closing N third switches and N fourth switches in order to cause signal U^{k}_{i,j} to be added to signal U^{k}_{i-1,j} if sublayer i is the last sublayer of layer j; and setting a result of adding U^{k}_{i,j} to V^{k}_{i,j} to zero if the result is below a threshold value. In one embodiment of the method, the first N amplitude modulators, the first N phase modulators, the diffractive block, the second N phase modulators, and the second N amplitude modulators form a first optical transceiver of sublayer i layer j of the neural network; in such embodiments the method further includes, in part, cascading the first transceiver with a second optical transceiver associated with the sublayer (i+1) of the layer j of the neural network.

In one embodiment, the optical neural network is trained to acquire images of objects and classify the objects. In one embodiment, the optical neural network is trained to operate as a vision system of an autonomous driving vehicle. In one embodiment, the optical neural network, the vision system is a distributed vision system. In one embodiment, the optical neural network is trained to operate as an artificial intelligence accelerator. In one embodiment, the artificial intelligence accelerator is disposed in a data center. In one embodiment, the artificial intelligence accelerator is disposed in a personal computer.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a simplified block diagram of an optical neural network, in accordance with one exemplary embodiment of the present disclosure.

FIG. 2 is a simplified block diagram of the input receiver of the optical neural network of FIG. 1, in accordance with one exemplary embodiment of the present disclosure.

FIG. 3 is a simplified block diagram of transceiver 300 shown in FIG. 1, in accordance with one exemplary embodiment of the present disclosure.

FIG. 4 shows an optical transmitter with a non-linear optical component, in accordance with one embodiment of the present disclosure.

FIG. 5 shows an optical receiver with a non-linear optical component, in

accordance with one embodiment of the present disclosure.

FIG. 6A and 6B are partial block diagrams of an optical neural network, in accordance with another exemplary embodiment of the present disclosure.

FIG. 7 is a simplified block diagram of an input receiver of an opto-electronic neural network, in accordance with one exemplary embodiment of the present disclosure.

FIG. 8 is a simplified block diagram of a transceiver of an opto-electronic neural network, in accordance with one exemplary embodiment of the present disclosure.

FIG. 9 is a simplified block diagram of an optical conversion unit of an opto- electronic neural network, in accordance with one exemplary embodiment of the present disclosure.

FIGS. 10A-10D collectively are a partial block diagram of an opto-electronic neural network, in accordance with one exemplary embodiment of the present disclosure.

FIG. 11 is a block diagram of a transceiver and non-linear component of a neural network, in accordance with one exemplary embodiment of the present disclosure.

FIG. 12 shows an assembly line of products that are being inspected using a neural network, in accordance with one embodiment of the present disclosure.

FIGS. 13A and 13B show vehicles that, in part, acquire, classify and distribute images of their surroundings using a neural network, in accordance with one embodiment of the present disclosure.

FIG. 14 shows a datacenter that includes a multitude of artificial intelligence accelerators formed using a multitude neural networks, in accordance with one embodiment of the present disclosure.

### DETAILED DESCRIPTION

Embodiments of the present disclosure are directed to a three-dimensional neural network (3DNN) formed using, in part, a transceiver of an optical phased arrays (OPA). The connectivity of the 3DNN is enabled by the Discrete Fourier Transform (DFT) matrix multiplication using diffraction. The weights are enabled and applied through wavefront engineering of the transmitter and receiver components of the transceiver.

Since the neurons on every layer of a 3DNN of the present disclosure are connected to one another through diffraction, the scalability and crosstalk that are otherwise present in wires or waveguide-based routing in electronic or photonic neural networks are eliminated. A 3DNN, in accordance with embodiments of the present disclosure, provides substantially enhanced scalability in forming large-scale electronic and/or photonic neural networks.

The wavefront modulation, in accordance with embodiments of the present disclosure, enables a distributed 3DNN to be formed between the transmitters and receivers in multiple configurations, thereby increasing scalability, as well as combining the high-bandwidth advantages of optical communications with deep neural networks on the same platform.

The photonic chips used as a modular building block of a distributed processor, provide highly-parallelized interconnections, which when combined with other components of the 3DNN, as described further below, readily provide for enhanced scaling of the neural networks. Moreover, the free-space propagation of the light in a 3DNN system readily enables implementation of the deep learning in the front-end of the 3DNN systems, by merging computing with sensing and communications.

As is described in detail below, a 3DNN, in accordance with embodiments of the present disclosure, may be used to create any N×N spectral matrix (SLN) and facilitate the multiplication of the matrix with any inputs. The photonic components when integrated with electronics using CMOS technology provide for a myriad of nonlinear activation functions to be implemented in the network.

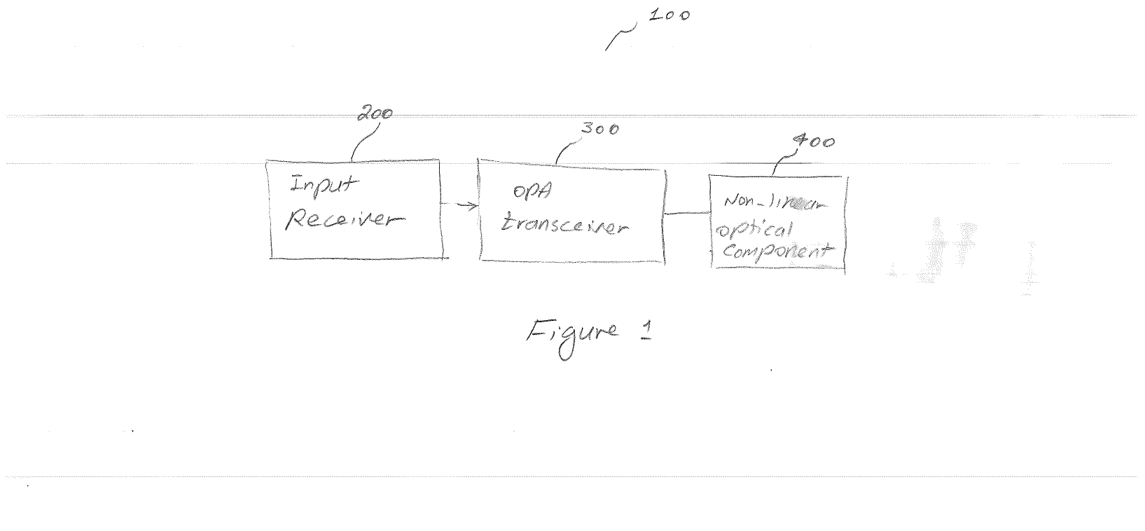

FIG. 1 is a simplified block diagram of an optical 3DNN 100, in accordance with one exemplary embodiment of the present disclosure. Optical 3DNN 100 is shown as including, in part, an input receiver 200, an optical phased-array transceiver 300, and a non-linear optical component 400, each of which is described in detail below. Exemplary optical 3DNN 100 is shown as having been configured to include 4 inputs (also referred to herein as channel), and perform a 4×4 matrix multiplication. It is understood, however, that embodiments of the present disclosure are not so limited, may include any number of channels, and perform any N×N matrix, where N is an integer equal to or greater than 2.

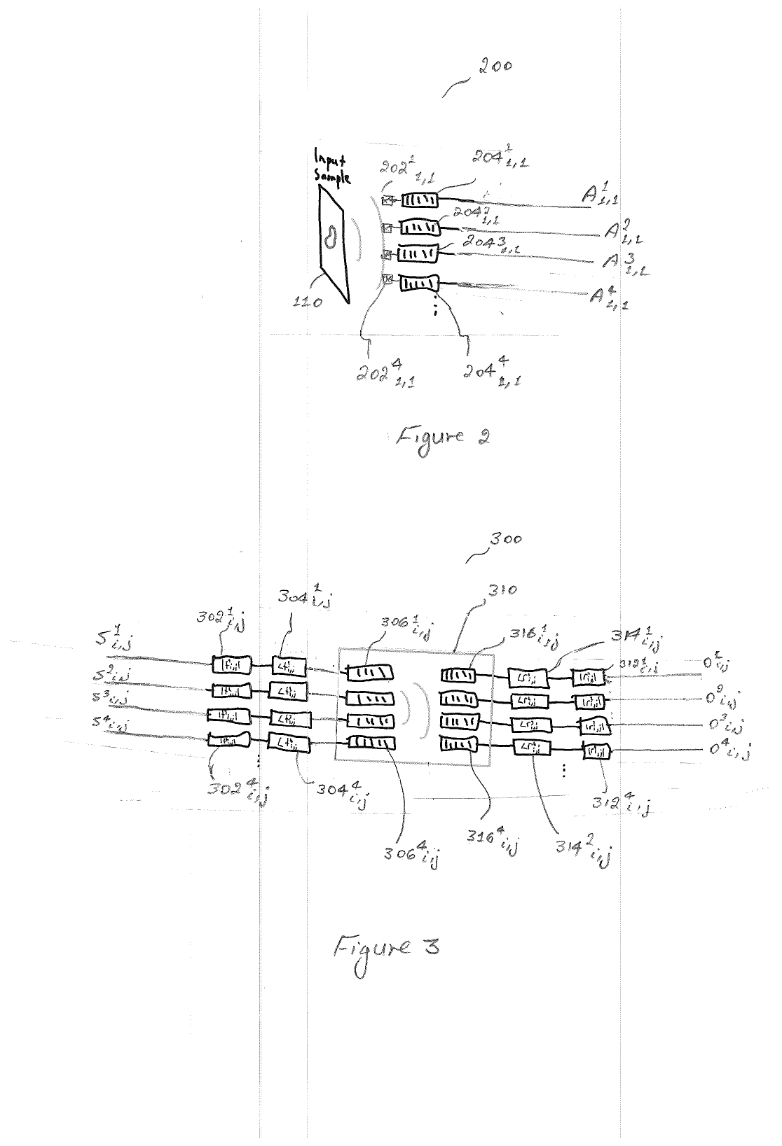

FIG. 2 is a simplified block diagram of input receiver 200 shown in FIG. 1, in accordance with one exemplary embodiment of the present disclosure. Exemplary input receiver 200 includes 4 receive antennas 20211,1, 20221,1, 20231,1, 20241,1, where the first sub-index denotes the sublayer number of the 3DNN corresponding to the diagonal matrix number that is applied to the input vector, and the second sub-index denotes the layer number of the 3DNN. Accordingly, because the input data is received at sublayer-1 of layer-1 both sub-indices are shown as 1. Each receive antenna is shown as receiving the light emitted from coherent light source 110, which may be a laser. Input receiver 200 is also shown as includes 4 optical antennas 204¹_{1,1}, 204²_{1,1}, 204³_{1,1}, and 204⁴_{1,1}. Optical antennas 204^{k}_{1,1} is associated with and receive the light from antenna 202^{k}_{1,1}, where k is an index referring to the channel number, which ranges from 1 to 4 in this example.

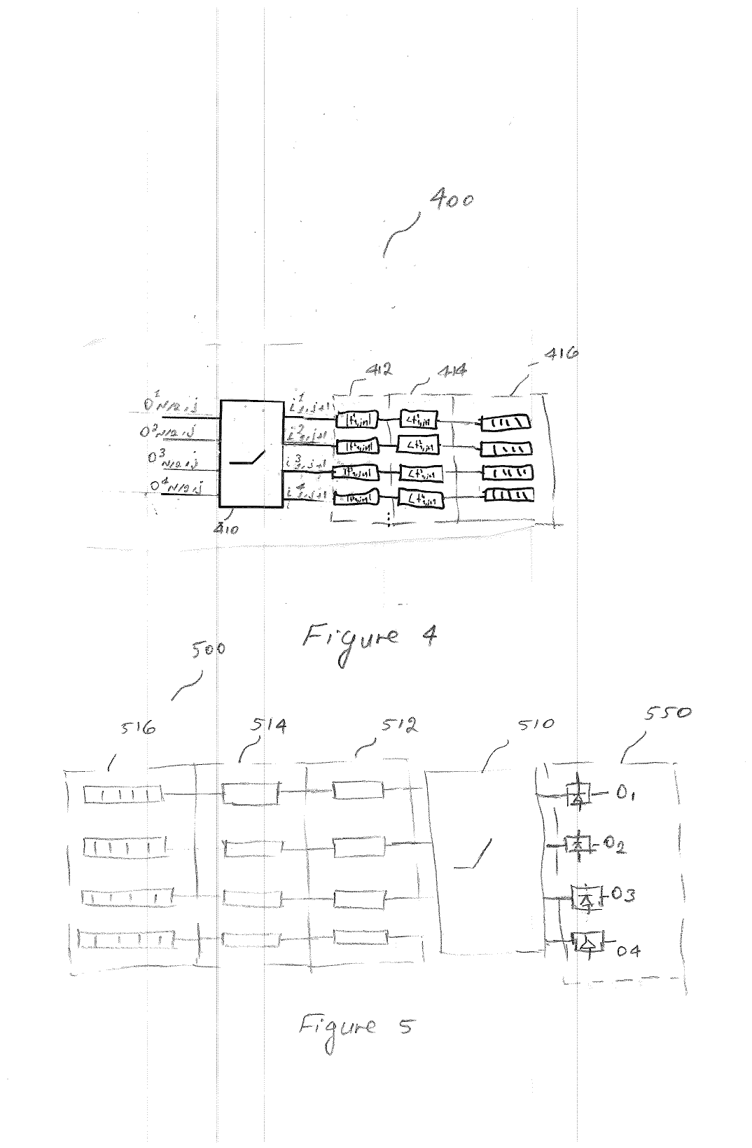

FIG. 3 is a simplified block diagram of transceiver 300 shown in FIG. 1, in accordance with one exemplary embodiment of the present disclosure. Transceiver 300 is shown as being associated with sublayer i of layer j of the 3DNN 100 of FIG. 1. Transceiver 300 is shown as including, in part, amplitude modulation blocks 302¹_{i,j}, 302²_{i,j}, 302³_{i,j}, 302⁴_{i,j} adapted to modulate the amplitude of their associated input signals S¹_{i,j}, S²_{i,j}, S³_{i,j}, S⁴_{i,j} respectively. Transceiver 300 is also shown as including, in part, phase modulation blocks 304¹_{i,j}, 304²_{i,j}, 304³_{i,j} 304⁴_{i,j} adapted to modulate the phase of the signals supplied by their associated amplitude modulation blocks 302¹_{i,j}, 302²_{i,j}, 302³_{i,j} 302⁴_{i,j}, respectively. Amplitude modulation blocks 302^{k}_{i,j} and phase modulation blocks 304^{k}_{i,j}, where k is an index ranging from 1 to 4 in this example, in part, form the transmitter of the optical phased array transceiver 300. The degree of modulations selected to be performed by the amplitude modulation blocks 302^{k}_{i,j} and phase modulation blocks 304^{k}_{i,j} represent the complex values of the diagonal matrix by which the input signal matrix S^{k}_{i,j} is multiplied with.

Transceiver 300 is also shown as including, in part, a diffraction block 310, which receives the result of matrix multiplication supplied at the input of diffraction block 310. Diffraction block 310 is shown as including, in part, input optical antennas 306^{k}_{i,j} each adapted to transmit the amplitude and phase modulated optical signal received thereby. Diffraction block 310 is also shown as including, in part, output optical antennas 316^{k}_{i,j} each adapted to receive the diffracted optical signal transmitted by its associated input optical antennas 306^{k}_{i,j}. The diffractions provided by diffraction block 310 represents a square static/circulant matrix that is multiplied by the matrix of values at the input of the diffraction block 310. The result of this matrix multiplication is supplied at the output of diffraction block 310.

Transceiver 300 is also shown as including, in part, phase modulation blocks 314^{k}_{i,j}, each adapted to modulate the amplitude of the optical signal received from an associated optical antenna 316^{k}_{i,j}. Transceiver 300 is further shown as including, in part, amplitude modulation blocks 312^{k}_{i,j}, each adapted to modulate the amplitude of the optical signal received from an associated phase modulation block 314^{k}_{i,j}. Phase modulation blocks 314^{k}_{i,j} and amplitude modulation blocks 312^{k}_{i,j} form, in part, the receiver of the optical phased array transceiver 300. The degree of modulations selected to be performed by the phase modulation blocks 314^{k}_{i,j} and amplitude modulation blocks 312^{k}_{i,j} represent the complex values of the diagonal matrix by which the values of the matrix at the output of diffraction block are multiplied with. The results of this matrix multiplication is supplied as outputs O^{k}_{i,j} of the transceiver. The matrix multiplications using optical signals are described in detail in Physica D: Nonlinear Phenomena, Volume 120, Issues 1-2, Sep. 1, 1998, pp. 196-205, entitled “Algorithmic design of diffractive optical systems for information processing”, by authors J. Muller-Quade, H. Aagedal, Th. Beth, and M. Schmid, the content of which is incorporated herein by reference in its entirety.

To provide the outputs supplied at each layer (neuron) for use in 3DNN 100, an activation function is performed on the matrix multiplication results provided at outputs O^{k}_{i,j} of the layer. Such an activation function may be performed by a non-linear optical component, such as a saturable absorber. Such a non-linear optical component causes received values that are smaller than a threshold value to be set to zero.

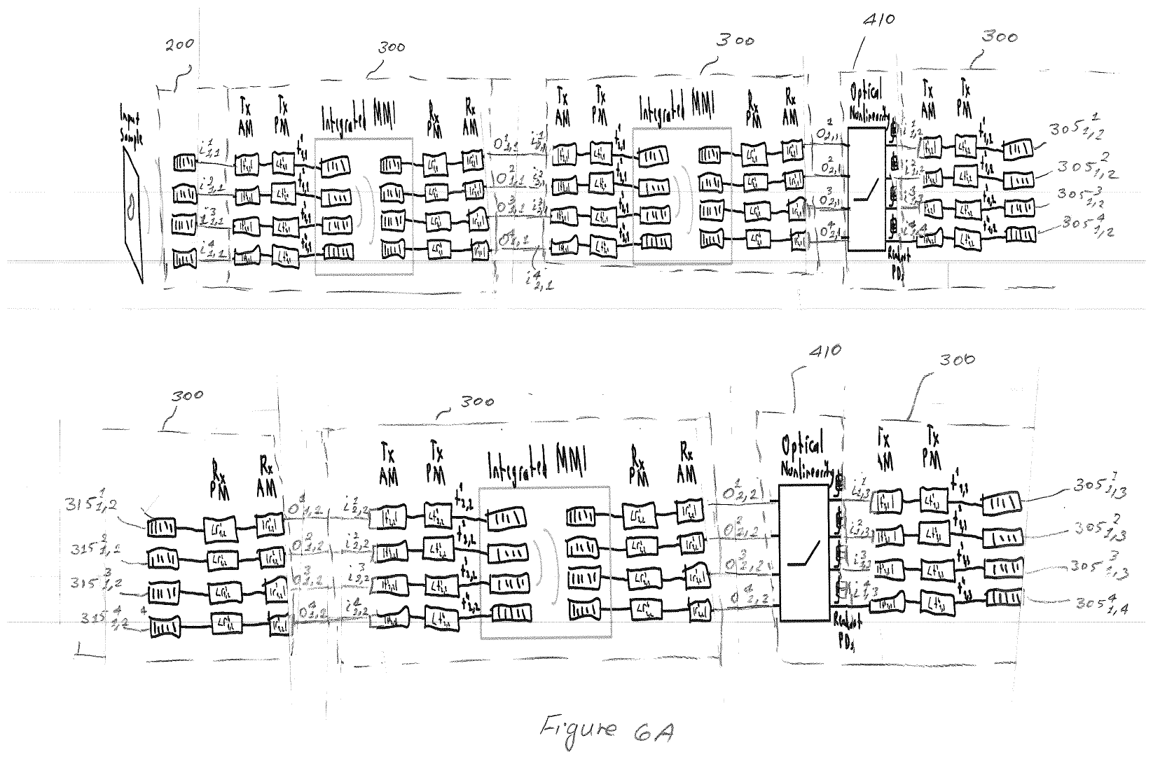

FIG. 4 shows an optical transmitter 400 that includes, in part, a non-linear optical component 410 that receives output signal O^{k}_{N/2,j} of layer j of a 3DNN, in accordance with one embodiment of the present disclosure, where k is an index ranging from 1 to 4. The matrix multiplications carried out in the example shown in FIG. 4 is cascaded so as to occur in 2 stages. For example, performing a 4×4 matrix multiplication is carried out in two stages with each stage performing a 2×2 matrix multiplication. Similarly, performing a N×N matrix multiplication is carried out in two stages with each stage performing a N×N/2 matrix multiplication.

Non-linear optical component 410 receives signal O^{k}_{N/2,j} associated with layer j, sets received signals whose values are less than a threshold value to zero, and supplies the results as input signals i^{k}_{i,j} for the next layer j+1 of the 3DNN. To transmit signals i^{k}_{i,j} to a different location, the amplitudes of signals i^{k}_{i,j} are modulated by amplitude modulators 412^{k}_{i,j} (collectively shown as 412), and the phases of amplitude modulated signals are subsequently modulated by phase modulators 414^{k}_{i,j} (collectively shown as 414). The outputs of phase modulators 414 are then delivered to optical antennas 416 for propagation in, for example, free-space and receipt by receiving optical antennas.

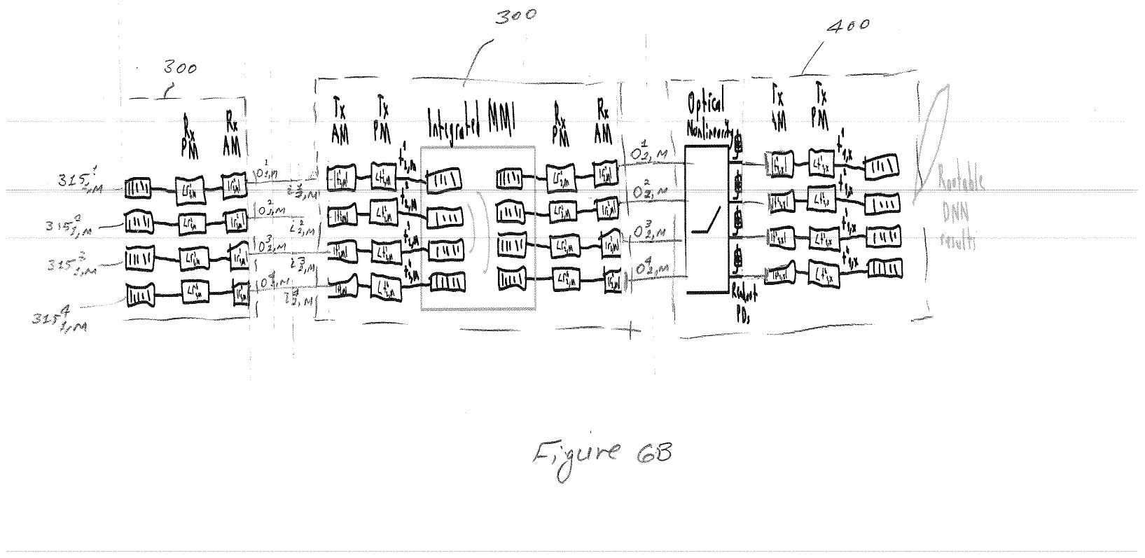

FIG. 5 shows an example of an optical receiver 500 adapted to receive the signals transmitted by an optical transmitter, such as optical transmitter 400 shown in FIG. 4. Optical receiver 500 is shown as including, in part, a multitude of optical antennas 516 each adapted to receive an optical signal transmitted by an associated one of optical antennas 416 of FIG. 4. Optical receiver 500 is also shown as including, in part, a multitude of phase modulators 514 each adapted to modulate the phase of the signal received from an associated one of the optical antennas 516. Optical receiver 500 is further shown as including, in part, a multitude of amplitude modulators 512 each adapted to modulate the amplitude of the signal received from an associated one of the phase modulators 514. The outputs of the amplitude modulators is delivered to non-linear optical component 510 adapted to perform a reverse activation function thus reversing the operation performed by non-linear optical component 410. Receiver 550 is also shown as optionally including a multitude of photodiodes, collectively shown as 550, each adapted to convert an associated optical signal received from non-linear optical component 550 to an electrical signal. The optional photodiodes are included when readout of the output of the non-linear optical component 550 is desired, or when the 3DNN is an opt-electronic 3DNN, described further below.

Referring to FIG. 3, diffraction/diffractive block 310 may be directly integrated on-chip with a dielectric slab of suitable dimensions. Such an implementation of a diffractive block would be most suitable when connectivity is needed on a single chip rather than on a distributed system. On the other hand, free-space propagation with antennas would be most suitable when the chip area is limited and each chip is used as a modular building block for a distributed processor or when concurrent processing and routing is needed, such as in communication or sensing-based applications (e.g., autonomous driving).

Optical transmitter 400 and receiver 500, shown in FIGS. 4 and 5 respectively, may be the final building blocks of each 3DNN layer as well the final building blocks of a 3DNN. Transmitter 400 may be used as the last sublayer of each 3DNN layer and be coupled to the first sublayer of the next layer of the 3DNN. The receiver may be used as the last sublayer of the last 3DNN layer.

The various blocks described with reference to FIGS. 1-5 above may be connected in various configurations to implement any desired 3DNN. The number of neurons between layers can also be varied by changing the number of antennas and waveguides of the transmitter and receiver of the transceiver block.

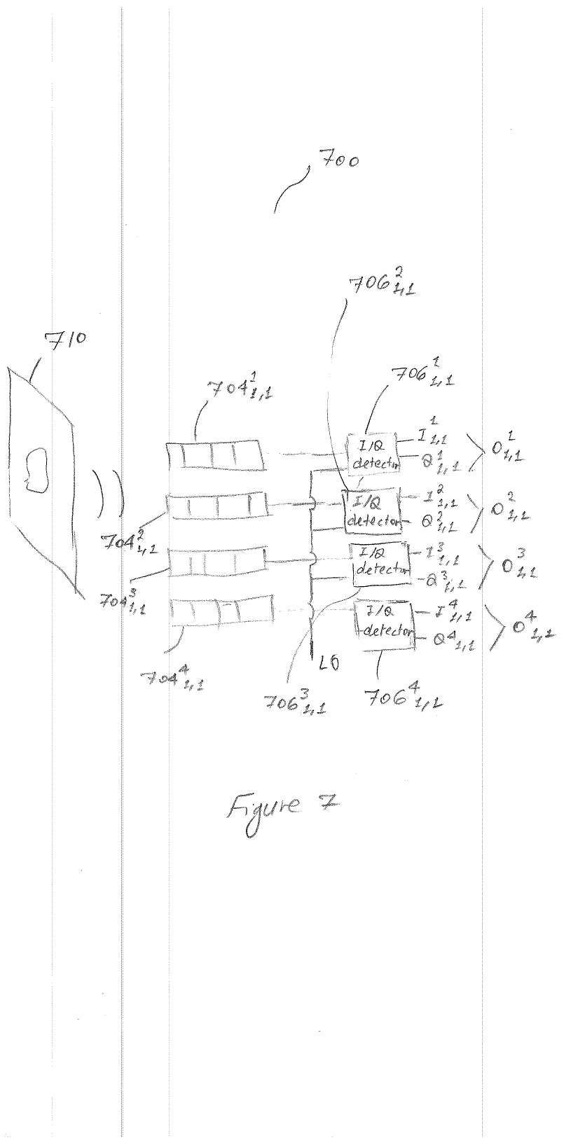

FIGS. 6A and 6B together are a partial block diagram of an exemplary configuration of 4-element (i.e., N=4), M-layer optical 3DNN 600 in which each of the layers includes N/2 sublayers. Input receiver 200, the details of which are described above with reference to FIG. 2, generates the 4-element input vector i^{k}_{1,1} where k refers to the element number ranging from 1 to 4 in this example. The signals supplied at inputs of the blocks in FIG. 6 are identified either as i^{k}_{i,j} or as r^{k}_{i,j}, where i is an index identifying the sublayer number ranging from 1 to N/2, and j is an index identifying the layer number. The signals supplied at outputs of the blocks in FIG. 6 are identified either as O^{k}_{i,j} or as t^{k}_{i,j}.

Transceiver 300—the details of which are described above with reference to FIG. 3—shown as receiving input signals i^{k}_{1,1}, generates output signals o^{k}_{1,1}. In a similar manner, transceiver 300, shown as receiving input signals i^{k}_{2,1} (i.e., the output signals o^{k}_{1,1}), generates output signals o^{k}_{2,1}. Because N is equal to 4 in this example, each layer includes 2 sublayers and hence 2 transceivers 300.

Non-linear optical component 410—the details of which are described above with reference to FIG. 4—shown as receiving signals o^{k}_{2,1}, generates signals i^{k}_{1,2} for the first sublayer of the second layer of the 3DNN 600. The transmit side of transceiver 300 shown as receiving signals i^{k}_{1,2}, supply signals t^{k}_{1,2} via the optical antennas 305^{k}_{1,2}. Optical antennas 305^{k}_{1,2} of the receive side of transceiver 300 receive the optical signals transmitted by antennas 305^{k}_{1,2}. These optical signals are then phase and amplitude modulated and supplied as output signals O^{k}_{1,2}.

Signals O^{k}_{1,2} are received as input signals to transceiver 300 disposed in the second sublayer of the second layer of 3DNN 600 as input signals i^{k}_{2,2}. The processing of the signals i^{k}_{2,2} is carried in the same manner as described above with respect to signals i^{k}_{1,1}. Non-linear optical component 410 receives signals o^{k}_{2,2} and generates signals i^{k}_{1,3} for the first sublayer of the third layer of the 3DNN 600. FIG. 6B shows the transceiver block 300 as well as the transmitter block 400 of the M^{th} layer. The remaining layers between the third layer and the M^{th} layer are not shown in FIGS. 6A and 6B. It is understood that optional photodiodes may be included at the outputs of each non-linear optical components 410 and 510 to perform a read-out of the values at each of the outputs of these blocks.

A 3DNN, in accordance with some embodiments of the present disclosure, may include both optical and electronic components. In some embodiments, an opto-electronic 3DNN includes an input receiver, transceiver(s), and optoelectronic converter(s) with switchable nonlinearity.

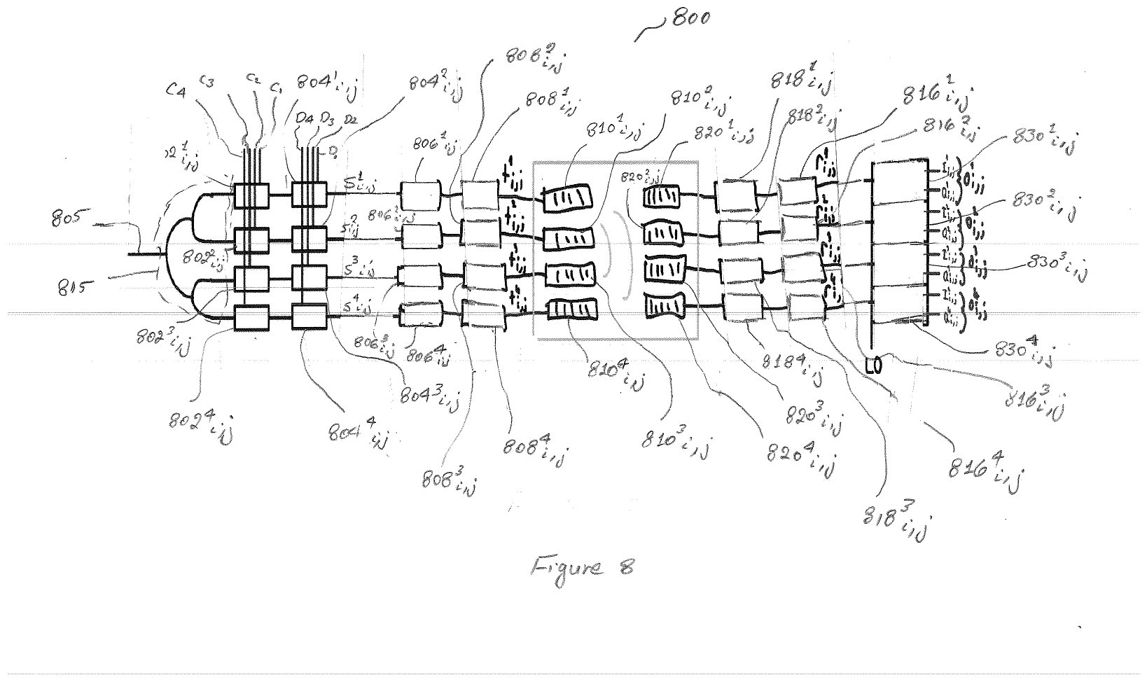

FIG. 7 is a simplified block diagram of input receiver 700 of a 4-channel opto-electronic 3DNN, in accordance with one exemplary embodiment of the present disclosure. Exemplary input receiver 700 is shown as including optical antennas 704^{k}_{1,1}, where k is an index referring to the channel number ranging from 1 to 4 in this example. Each optical antenna receives a portion of the light emitted from coherent light source 710, which may be a laser. Input receiver 700 is also shown as including 4 I/Q detectors 706^{k}_{1,1} associated with optical antennas 704^{k}_{1,1}. Each I/Q detector 706^{k}_{1,1} receives the light from its associated optical antenna 704^{k}_{1,1} as well as an optical local oscillator (LO) signal to generate a pair of low-frequency in-phase (I) and quadrature-phase (Q) signals in response. The I and Q signals of each channel may be subsequently converted to electrical signals by, for example, a pair of photodiodes to generate signal i^{k}_{1,1} and Q^{k}_{1,1} associated with each channel. Signals i^{k}_{1,1} and Q^{k}_{1,1} of each channel are collectively referred as output signal O^{k}_{1,1} associated with the channel. In embodiments where conversion to electrical signals is not required, an optical input receiver as shown in FIG. 2 may be used.

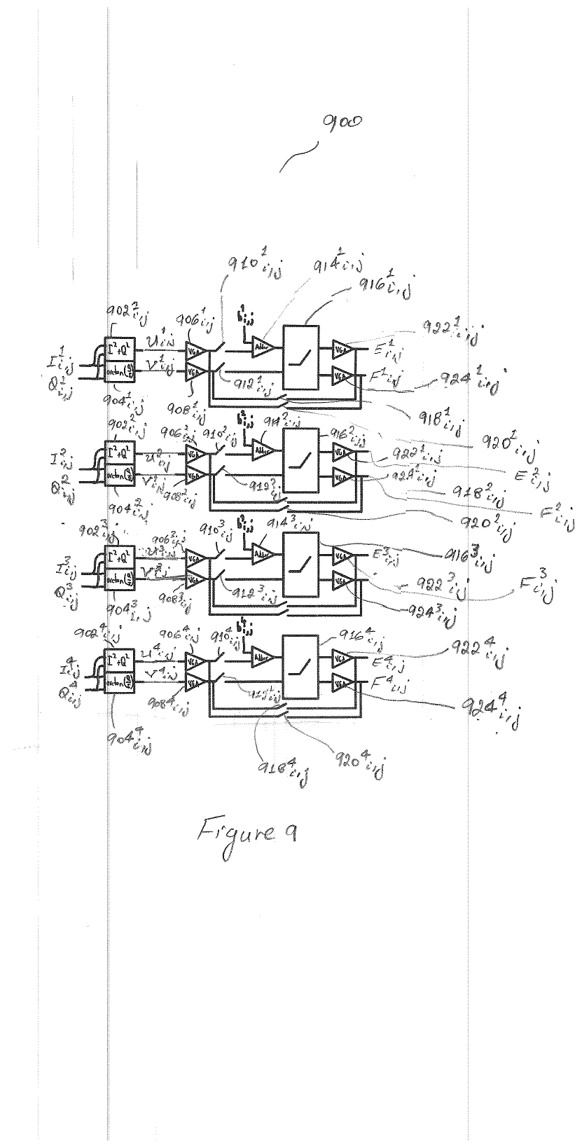

FIG. 8 is a simplified block diagram of a 4-channel transceiver 800 used together with input receiver 700 in an opto-electronic 3DNN, in accordance with one exemplary embodiment of the present disclosure. Although exemplary transceiver 800 is shown as including 4-channels, it is understood that transceiver 800 may include any number of channels. Transceiver 800 is shown as being associated with sublayer i of layer j of an opto-electronic 3DNN.

Light received via waveguide 805 is split into four channels by power splitter tree 815 and delivered to amplitude modulators 802^{k}_{i,j}, where k represent the channel number ranging from 1 to 4 in this example. Amplitude modulation is performed in accordance with electrical signals Cₖ applied to amplitude modulators 802^{k}_{i,j}. Phase modulators 804^{k}_{i,j} receive and modulate the phase of the amplitude modulated signals in accordance with electrical signals Dₖ applied to phase modulators 804^{k}_{i,j}. Signals Cₖ and Dₖ are used to map the amplitude and phase information of the output light of the receiver of the previous sublayer (i−1) to the transmitter of the current sublayer i.

Amplitude and phase modulated signals S^{k}_{i,j} supplied at the outputs of phase modulators 804^{k}_{i,j} are delivered to amplitude modulators 806^{k}_{i,j} and phase modulators 808^{k}_{i,j} which further modulate the amplitudes and the phases of signals S^{k}_{i,j} in accordance with signals applied to modulators 804^{k}_{i,j} and 806^{k}_{i,j} (not shown) representative of the weights applied to sublayer i. The output signals t^{k}_{i,j} supplied by phase modulators 806^{k}_{i,j} are transmitted by transmitting optical antennas 810^{k}_{i,j} and received by receiving optical antennas 820^{k}_{i,j}. The signals received by optical antennas 820^{k}_{i,j} are phase-modulated by phase modulators 818^{k}_{i,j} and amplitude-modulated by amplitude modulators 816^{k}_{i,j}. Signals r^{k}_{i,j} supplied at the outputs of phase modulators 818^{k}_{i,j} are converted into in-phase signals I^{k}_{i,j} and quadrature-phase signals Q^{k}_{i,j} by I/Q detectors 830^{k}_{1,1} to acquire the amplitude and phase information for the current sublayer i. The matrix multiplication operations performed by transceiver 800 are similar to those described with reference to transceiver 300. When optoelectronic conversion is not required, an all-optical transceiver, as described above, can be used.

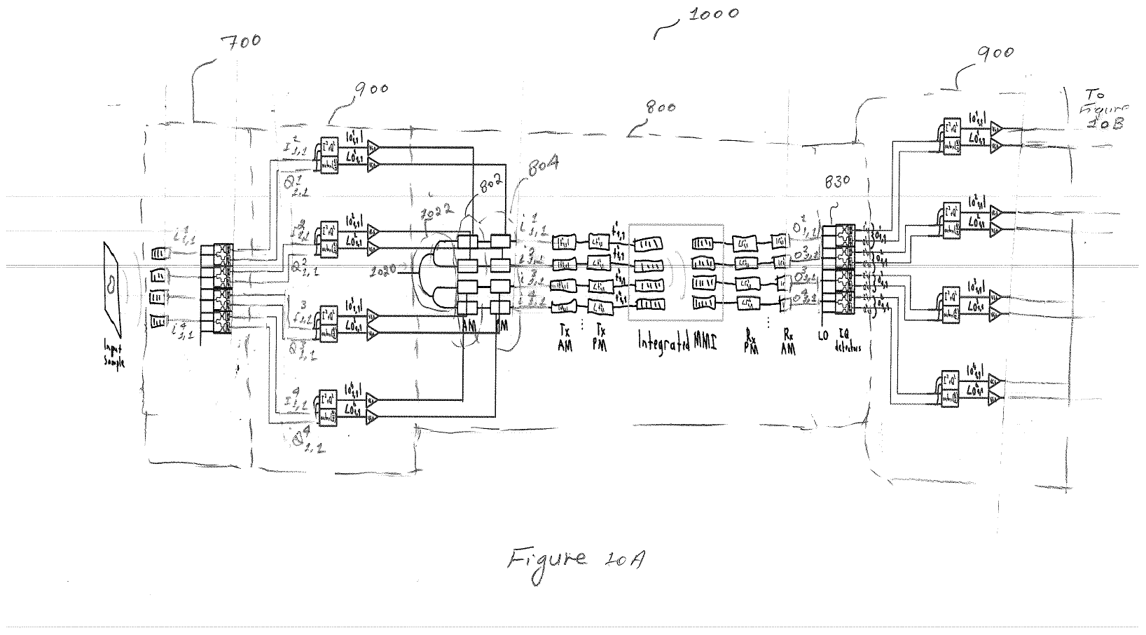

FIG. 9 is a simplified block diagram of a 4-channel optical conversion unit (OCU) 900 used in an opto-electronic 3DNN, in accordance with one exemplary embodiment of the present disclosure. Optical conversion unit 900 is shown as including only electronic components. Input signals I^{k}_{i,j} and Q^{k}_{i,j}, where k is an index identifying the channel number and ranging from 1 to 4 in this example, are received by signal processing blocks 902^{k}_{i,j} and 904^{k}_{i,j}, which in response generate signals U^{k}_{i,j} and V^{k}_{i,j} representative of the magnitude and phase of the received signals I^{k}_{i,j} and Q^{k}_{i,j}. Signals U^{k}_{i,j} and V^{k}_{i,j} are respectively amplified by variable gain amplifiers (VGA) 906^{k}_{i,j} and 908^{k}_{i,j}.

If the optical conversion unit is not disposed in the last sublayer of a DNN layer, then switches 910^{k}_{i,j} and 912^{k}_{i,j} are caused to open and switches 918^{k}_{i,j} and 920^{k}_{i,j} are caused to close, thereby causing the outputs of VGAs 906^{k}_{i,j} and 908^{k}_{i,j} to be supplied as output signals E^{k}_{i,j} and F^{k}_{i,j} of the optical conversion unit. If, however, the optical conversion unit is disposed in the last sublayer of a layer, then switches 910^{k}_{i,j} and 912^{k}_{i,j} are caused to close and switches 918^{k}_{i,j} and 920^{k}_{i,j} are caused to open. Accordingly, the magnitude signal U^{k}_{i,j} of sublayer is added, using adder 914^{k}_{i,j}, to the magnitude signal U^{k}_{i-1,j} generated by optical conversion unit of previous sublayer (i−1). The output of the adder 914^{k}_{i,j} is then applied to non-linear optical component 916^{k}_{i,j} which, in response, sets the received signal to zero if the value of the received signal is less than a threshold value. The output signals of non-linear optical component 916^{k}_{i,j} are amplified by VGAs 922^{k}_{i,j}, 924^{k}_{i,j} and supplied as output signals U^{k}_{i,j} and V^{k}_{i,j}.

Optical conversion unit 900 may further be used when optical to electrical signal conversion is advantageous between layers since it provides for a wide selection of electronic nonlinearities to be used between the 3DNN layers. However, to minimize optoelectronic conversion errors and to maximize bandwidth, all-optical versions of the building blocks can be used especially to connect sublayers of the 3DNN, where nonlinearity is not needed.

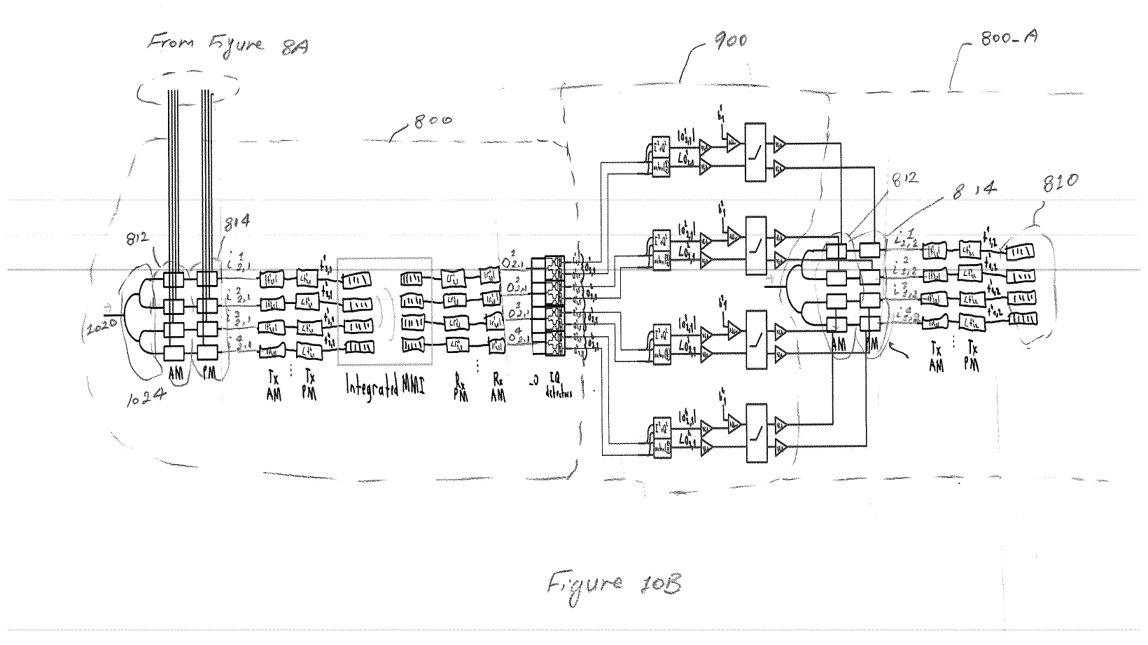

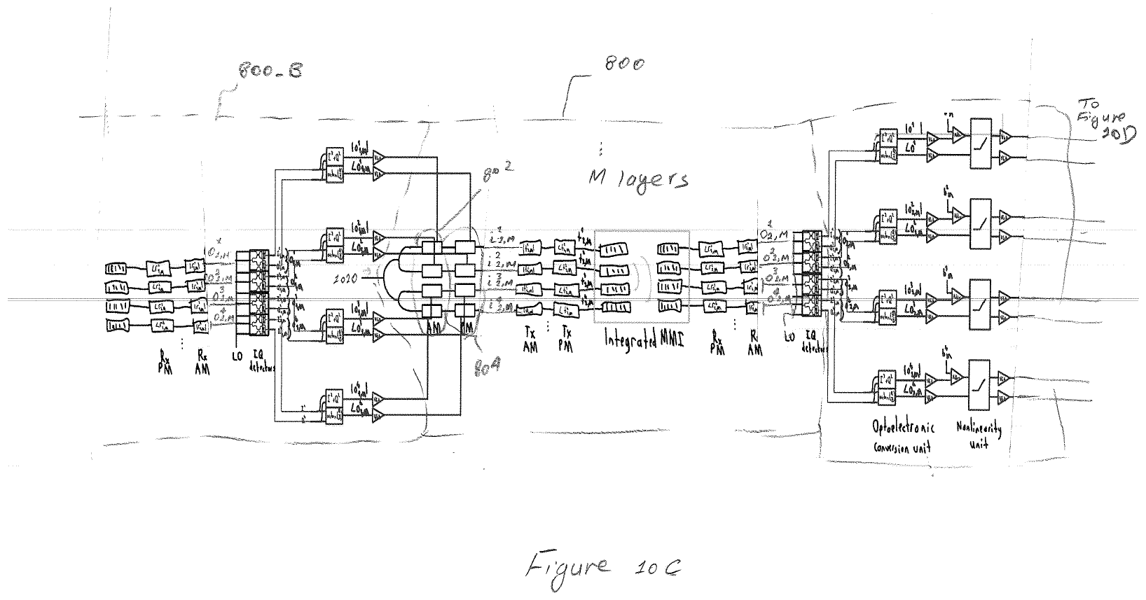

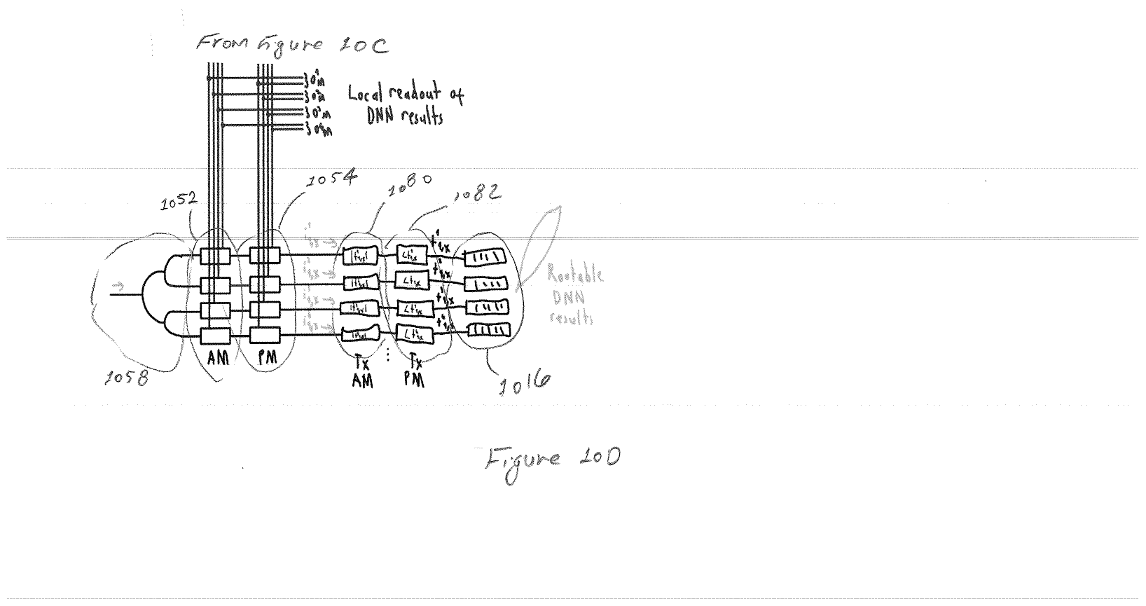

FIGS. 10A-10D collectively show an exemplary embodiment of a 4-channel 3DNN 1000 that includes M layers and uses photonic and electronic components/blocks. For simplicity, only 3 of the M layer of 3DNN 1000 are shown in FIGS. 10A-10D. Input receiver 700 receives the light supplied by light source 1010 and supplies 4 in-phase and 4 quadrature-phase signals at its output. The 8 outputs of input receiver 700 are delivered to OCU 900 in which switches 910 and 912 (corresponding to switches 910^{k}_{i,j} and 912^{k}_{i,j} of OCU 900) are open and switches 918 and 920 (corresponding to switches 918^{k}_{i,j} and 920^{k}_{i,j} of OCU 900) are closed. The 8 electrical output signals of OCU 900 are applied to transceiver 800 to modulate the amplitudes and phases of the optical signal supplied by optical source 1020 and flowing through the power splitting tree 1022 of transceiver 800. Transceiver 800 generates the signals O^{k}_{1,1} that subsequently undergo I/Q conversion by block 830 disposed in the transceiver and applied to a second instantiation of OCU 900.

In the second instantiation of OCU 900 switches 910 and 912 are open and switches 918 and 920 are closed. The 8 output signals of the second instantiation OCU 900 are applied to transceiver 800 shown in FIG. 10B and are used to modulate the light travelling in amplitude modulators 812 and phase modulators 814. The light is supplied to the amplitude and phase modulators 812 and 814 is by power splitting tree which receives the light from light source 1020. Transceiver 800 of FIG. 10B generates the signals O^{k}_{2,1} that subsequently undergo I/Q conversion by block 830 disposed in the transceiver and applied to a second instantiation of OCU 900 shown in FIG. 10B. In OCU 900 shown in FIG. 10B, switches 910 and 912 are closed and switches 918 and 920 are open.

The 8 outputs of OCU 900 of FIG. 10B are applied to another instantiation of transceiver 800, a transmitting portion of which 800-A is shown in FIG. 10B. The amplitude and phase modulated lights i^{k}_{1,2} are transmitted by antennas 810 of the diffraction block disposed in the transceiver. FIG. 10C shows the receiving portion 800-B of the first sublayer of the M^{th} layer of the 3DNN 1000 which generates signals O^{k}_{M,1} that after I/Q conversion are applied to another instantiation of transceiver 800 forming the second sublayer of the M^{th} layer of the 3DNN 1000. Transceiver 800 disposed in the second sublayer of layer M generates the signals O^{k}_{2,M} that after I/Q conversion are delivered to OCU 900. It is understood that the components of 3DNN 1000 between the second and the M^{th} layer of the 3DNN 1000 are not shown.

Four of the output signals of OCU 900 of FIG. 10C are applied to the 4 amplitude modulators of amplitude modulation block 1058 to modulate the amplitudes of the optical signals travelling through the 4 branches of power splitter tree 1058. The other four output signals of OCU 900 of FIG. 10C are applied to the 4 phase modulators of phase modulation block 1054 to modulate the phases of the amplitude-modulated signals. The amplitude and phase modulated optical signals are shown being modulated in amplitude by amplitude modulators 1080 and being modulated in phase by phase modulators 1082 and routed using the 4 optical antennas collectively identified as 1016. It is understood that any combination of the various blocks described above with references to FIGS. 1-10 may be used to form a highly-modular, programmable neural network, in accordance with embodiments of the present disclosure.

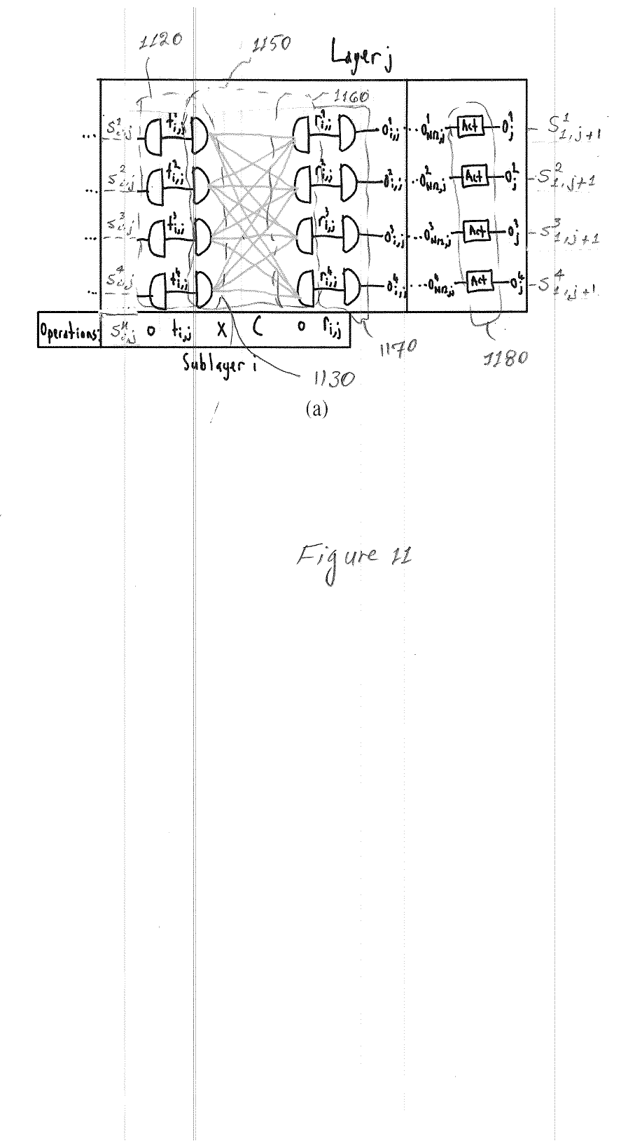

Additional description of the matrix operations performed by embodiments of the present invention is provided with reference to FIG. 11. When light from an object impinges on the receiving aperture of a 3DNN, each input receiver antenna acquires the amplitude and phase information of the object, where the resolution is determined by the number of antennas in the receiving aperture. The acquired amplitude and phase information are then passed to the transmitter serving as the input to the 3DNN′s first sublayer of the first layer expressed as the vector S^{k}_{i,j}, where k represent the channel or element number shown as being 4 in FIG. 11. Using the amplitude modulation (AM) and phase modulation (PM) blocks of the 3DNN's transceiver, such as amplitude modulation block 302^{k}_{i,j} and phase modulation block 304^{k}_{i,j} described above with reference to FIG. 3, vector S^{k}_{i,j} goes through a Hadamard multiplication with the complex AM/PM transmitter weights t^{k}_{i,j}, as supplied by AM/TM bock 1120, to generate the product (S^{k}_{i,j}o t^{k}_{i,j}), which is subsequently radiated by the optical antennas of diffractive block 1150.

Via free-space diffraction, the resulting vector goes through a matrix multiplication with a circulant matrix C^{k}_{i,j} to generate the result S^{k}_{i,j}o t^{k}_{i,j} C^{k}_{i,j}. In accordance with one aspect of the present, the circulant matrix defined by a static discrete Fourier transform (DFT) operation is made reconfigurable by providing additional layers of receiver and transmitter in each diffractive block since the matrix FDF⁻¹, in which matrix F represents the DFT matrix and matrix D is a diagonal matrix representing the combined amplitude modulation and phase modulation, diagonalizes any circulant matrix.

In some embodiments, fractional Fourier transform may be used by operating the diffractive blocks with reconfigurable distances (e.g., by using thermo-optic modulation of the refractive index in the diffractive block or by mechanically reconfiguring the distance) in the near-field to form any circulant matrix. The circulant matrix facilitated by free-space propagation disposed between diagonal matrices allows for the realization of any matrix multiplication where the matrix can be any M×N matrix, including in the special linear group.

As is described in detail above with reference to FIGS. 1-10, after the circulant matrix operation, the resulting light field, as received by the receiver 1160 (also referred to herein as receiving elements) of the diffractive block 1150, goes through another Hadamard multiplication using the weights provided by the amplitude modulation blocks and the phase modulation blocks 1170 of the receiver to generate the matrix (O^{k}_{i,j}=S^{k}_{i,j}o t^{k}_{i,j} C^{k}_{i,j}o r^{k}_{i,j}). The resulting matrix (also referred to as field) O^{k}_{i,j} is the output of sublayer i of layer j of a 3DNN layer. As is described above, for example, with reference to FIG. 6, the sublayers are cascaded until the degree-of-freedom (DoF) requirement is satisfied, and the result of the N×N matrix is generated for which N² DoFs are required. Since the weight vector provided by each AM/PM includes N elements, each sublayer provides 2N DoFs. Therefore, N/2 sublayers are needed for each layer:

$${O}_{N / 2 , j} = {o}_{i , j} {\prod }_{i = 1}^{N / 2} {M}_{i , j} ,$$

where M_{i,j} is the matrix constructed in each sublayer.

In some embodiments, as described above, after each layer, a nonlinearity (i.e., activation function), such as the non-linearity provided by block 1180 of FIG. 11, is provided either in the optical domain or electrical domain with or without added bias (bⱼ). In one exemplary embodiment where multiple layers are needed, the resulting outputs O^{k}ⱼ are passed to the first transceiver of the next layer as signals S^{k}_{1,j+1}. In another exemplary embodiment, the results are read out with read-out electronic components, such as photodiodes. In yet another exemplary embodiment, the results are routed to another location with an OPA transmitter and read out or processed in another location.

Because an optical 3DNN, in accordance with embodiments of the present disclosure, is highly modular, it can be configurated for use in a multitude of highly- scalable platforms and be provisioned to interface with electronic components with relative ease. Photonic integrated circuits using highly-nonlinear materials, such as Lithium- Niobium (LiNb), may be used as a non-linear component to perform the activation function. optical nonlinearity in the 3DNN. In some embodiments, a 3DNN is a programmable meta surface-based 3DNNs. In yet other embodiments, the 3DNN may be formed using bulk optical components, such as spatial light modulators (SLMs) and photodiode arrays.

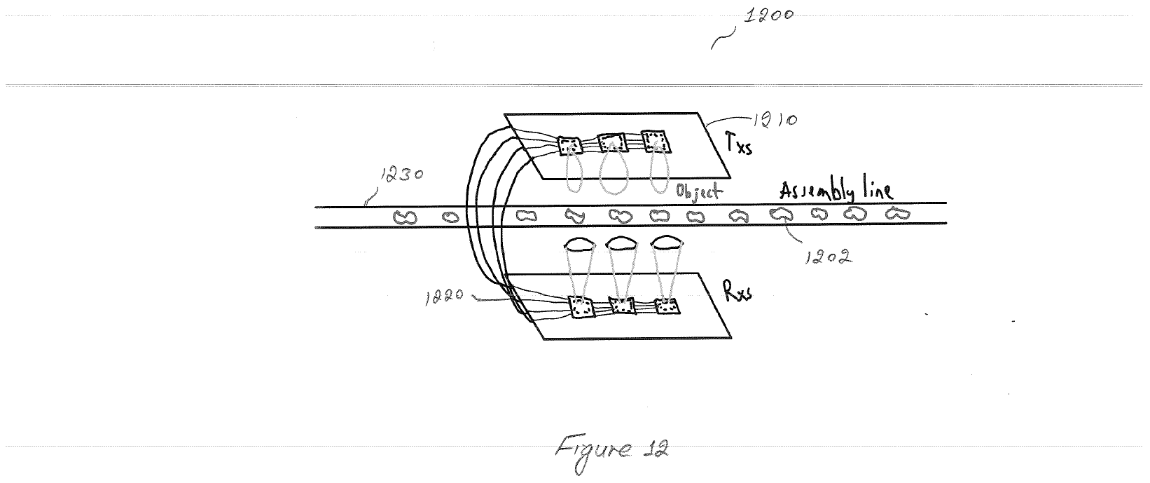

A 3DNN, in accordance with embodiments of the present disclosure, may be used to form a compact, low-cost classifier and imager as shown in FIG. 12. Such a classifier and imager may be used, for example, in warehouses or factories, where a low-power and high-speed inspection of product defects is performed as part of a quality control program. In FIG. 12, the 3DNN OPA transceiver, which includes transmitter 1210 and receiver 1220, is shown as forming 3D image of manufactured object 1202 as they move along the assembly line 1230. The images received are used by the 3DNN for classification and inspection. The 3DNN thus dispenses the need for resource-intensive digitization of images and subsequent delivery of the image data to an electronic neural network while maintaining the flexibility to image the objects for human supervision.

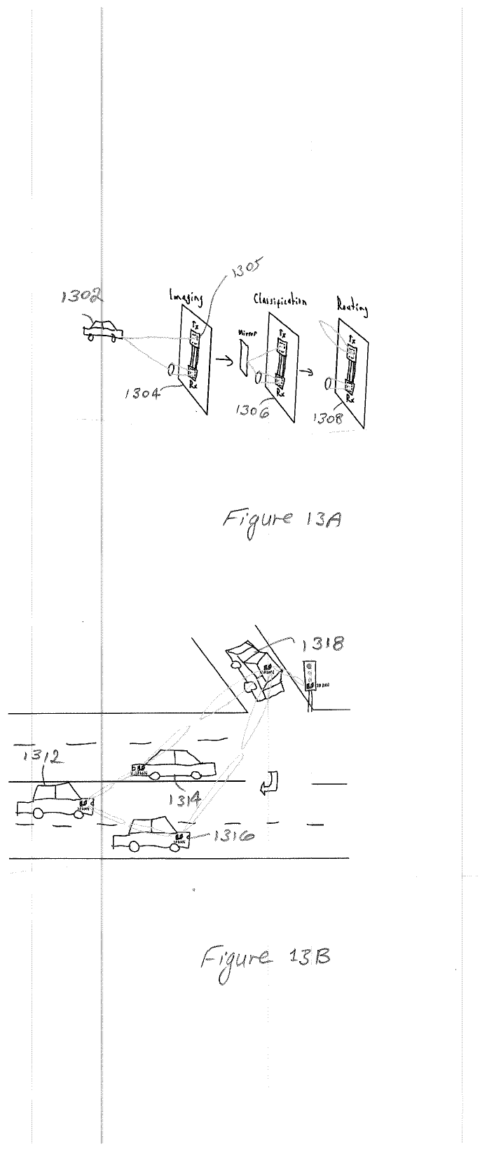

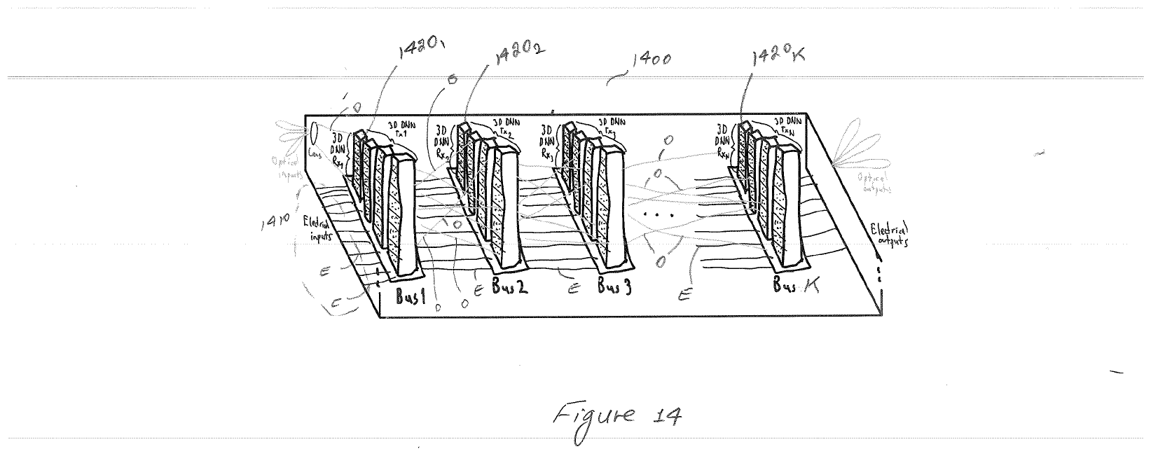

Another example application of a 3DNN, in accordance with embodiments of the present disclosure, is in computer vision systems for use in autonomous driving or remote sensing application, as shown in FIGS. 13A and 13B. The multitude of sublayers, layers, of 3DNN, or a 3DNN in its entirety may be distributed among vehicles and devices with wireless connectivity. In FIG. 13A, the 3DNN disposed in vehicle 1302 is trained to image object 1305 at 1304, classify it at 1306, and route the classified information at 1308 to other vehicles nearby or to a center. In FIG. 13B, the 3DNNs disposed in vehicles 1312, 1314, and 1316 are shown as acquiring image of vehicle 1138, classifying the acquired image and distributing the classified information so as to achieve a distributed computer vision system for autonomous driving and/or Internet-of-Things (IoT) application. Accordingly, a distributed neural networks with an exceptionally vast scale may be formed using 3DNNs, in accordance with embodiments of the present disclosure. Since a 3DNN is a multi-purpose neural network, it can again be reconfigured for 3D imaging and sensing with neural network processing accessible at the front end.

FIG. 14 shows a multitude of 3DNNs that are coupled to form a large-scale general-purpose artificial intelligence (AI) accelerators for a data center (or a personal computer). Datacenter 1400 is shown as including, in part, K 3DNN 1420, namely 1420₁, 1420₂ . . . 1420_{N}. The values of amplitude modulations and pulse modulations are supplied using electrical signals 1420. The electrical signals are identified as “E”, and the optical signals are identified as “O”. Because a 3DNN, in accordance with embodiments of the present disclosure, is modular, the 3DNN sublayers and layers can be formed modularly with a relatively large number of chips having the flexibility of both optical and electrical interconnects. Therefore, buses of 3DNN layers can be formed in a highly compact and parallelized fashion, where all chips are interconnected without any crossing issues. When space becomes a limitation, time-domain cycling may be utilized to further increase the number of layers. This enables large-scale highly-parallelized neural networks to be formed while benefiting from the low-power consumption and high bandwidth of all-optical parallelized matrix multiplication. Individual accelerators can be further modularized in a data center to form a large-scale distributed accelerator with optical and electrical options for interconnects. As the above example show, a 3DNN, in accordance with embodiments of the present disclosure, overcomes many of the challenges in interconnect, power consumption, and bandwidths associated with electronic neural networks, using for example graphical processing units (GPUs) and provides a highly scalable and parallelized architecture.

The above embodiments of the present invention are illustrative and not limitative. Other additions, subtractions or modifications are obvious in view of the present disclosure and are intended to fall within the scope of the appended claims.

1. An optical neural network comprising a plurality of N-element layers each comprising a plurality of N-element sublayers, wherein sublayer i of layer j of the neural network comprises a transceiver, the transceiver comprising:
N first optical amplitude modulators each adapted to modulate an amplitude of an optical signal S^{k}_{i,j}, wherein k is an index identifying the element number ranging from 1 to N;
N first optical phase modulators each adapted to modulate a phase of an amplitude-modulated signal supplied by an associated one of the N first optical amplitude modulators, wherein an amount of modulations selected to be performed by the N first amplitude modulator and the N first phase modulators represent values of a first matrix by which the optical signal matrix S^{k}_{i,j} is multiplied;
a diffractive block comprising:
N optical transmit antennas each adapted to transmit the phase-modulated signal supplied by an associated one of the N first phase optical modulators; and
N optical receive antennas each adapted to receive the optical signal transmitted by an associated one of the N transmit optical antennas, wherein diffractions provided by the diffractive clock represent a square circulant matrix;
N second optical phase modulators each adapted to modulate a phase of an optical signal received by an associated one of the N optical receive antennas; and
N second optical amplitude modulators each adapted to modulate an amplitude of a phase-modulated signal supplied by an associated one of the N second phase modulators, wherein the modulations selected to be performed by the N second amplitude modulator and N second phase modulators represent values of a second matrix by which the circulant matrix is multiplied with.

2. The optical neural network of claim 1 further comprising:
an input optical receiver comprising N optical antennas each receiving a light emitted by a coherent source of light and delivering the received light to the N first optical amplitude modulators of the first sublayer of the first layer of the neural network.

3. The optical neural network of claim 2 further comprising:
an N-element non-linear optical component adapted to receive and set values of each of the N second optical amplitude-modulated signals that are below a threshold value to zero.

4. The optical neural network of claim 3 wherein the neural network comprises a second transceiver associated with the sublayer (i+1) of the layer j of the neural network, wherein the second transceiver is cascaded with the transceiver of the sublayer i of the layer j of the neural network.

5. The optical neural network of claim 4 comprising:
N optical-to-electrical signal converters each associated with and coupled to a different one of N outputs of the non-linear optical component to convert the optical signal supplied at the associated output to an electrical signal.

6. An opto-electronic neural network comprising a plurality of N-element layers each comprising a plurality of N-element sublayers, wherein sublayer i of layer j of the neural network comprises:
N first amplitude modulators each adapted to modulate an amplitude of an optical signal received from a power splitter via a first associated electrical signal;
N first phase modulators each associated with a different one of the N first amplitude modulators and adapted to modulate a phase of an optical signal received from the associated amplitude modulator via a second associated electrical signal; and
a transceiver comprising:
N first optical amplitude modulators each adapted to modulate an amplitude of an optical signal S^{k}_{i,j} received from an associated one of the N first phase modulators, wherein k is an index identifying the element number ranging from 1 to N;
N first optical phase modulators each adapted to modulate a phase of an amplitude-modulated signal supplied by an associated one of the N first optical amplitude modulators, wherein the amount of modulations selected to be performed by the N first amplitude modulator and the N first phase modulators represent values of a first matrix by which the optical signal matrix S^{k}_{i,j} is multiplied;
a diffractive block comprising:
N optical transmit antennas each adapted to transmit the phase-modulated signal supplied by an associated one of the N first phase optical modulators; and
N optical receive antennas each adapted to receive the optical signal transmitted by an associated one of the N optical transmit antennas, wherein diffractions provided by the diffractive block represents a square circulant matrix;
N second optical phase modulators each adapted to modulate a phase of an optical signal received by an associated one of the N receivers; and
N second optical amplitude modulators each adapted to modulate an amplitude of a phase-modulated signal supplied by an associated one of the N second phase modulators, wherein the modulations selected to be performed by the N second amplitude modulator and N second phase modulators represent values of a second matrix by which the circulant matrix is multiplied with.

7. The opto-electronic neural network of claim 6 further comprising:
N in-phase (I) and quadrature-phase (Q) detectors, each I/Q detector adapted to convert, using an optical local oscillator signal, an output signal of a different one of the N second optical amplitude modulators to an I signal and a Q signal; and
2N optical-to-electrical signal converters each associated with and adapted to convert a different one of N I signals and N Q signals to an electrical signal.

8. The opto-electronic neural network of claim 7 further comprising an optical conversion unit (OCU), the OCU comprising:
a first N signal processing blocks each associated with a different one of the N I electrical signals;
a second N signal processing blocks each associated with a different one of the N Q electrical signals, wherein the first N signal processing blocks and the second N processing blocks associated with the same element k are adapted to generate signals U^{k}_{i,j} and V^{k}_{i,j} representative of the magnitude and phase of the signals I^{k}_{i,j} and Q^{k}_{i,j} received by the element k.

9. The opto-electronic neural network of claim 8 further comprising:
N first variable gain amplifiers each adapted to amplify an associated U^{k}_{i,j} signals;
and
N second variable gain amplifiers each adapted to amplify an associated V^{k}_{i,j} signals.

10. The opto-electronic neural network of claim 9 further comprising:
N first switches and N second switches that are closed to supply the amplified U^{k}_{i,j} signals and V^{k}_{i,j} signals as output signals of the OCU if sublayer i is not the last sublayer of layer j;
N third switches and N fourth switches that are closed to cause signal U^{k}_{i,j} to be added to signal U^{k}_{i-1,j} if sublayer i is the last sublayer of layer j; and
a non-linear optical component adapted to receive a result of adding signals U^{k}_{i,j} to U^{k}_{i-1,j} and set values of each of the received signals that are below a threshold value to zero.

11. The opto-electronic neural network of claim 10 wherein the opto-electronic neural network comprises a second transceiver associated with the sublayer (i+1) of the layer j of the neural network, wherein the second transceiver is cascaded with the transceiver of the sublayer i of the layer j of the neural network.

12. A method of forming an optical neural network comprising a plurality of N-element layers each comprising a plurality of N-element sublayers, the method comprising:
modulating an amplitude of each of N first optical signal S^{k}_{i,j} by first N amplitude modulators, wherein k is an index representing the element number ranging from 1 to N, i represents a sublayer number, and j represents a layer number of the optical neural network;
modulating a phase of each of the N first amplitude modulated optical signals by first N phase modulators, wherein an amount of modulations selected for the first N amplitude modulations and the first N phase modulations represent values of a first matrix by which the optical signal matrix S^{k}_{i,j} is multiplied;
radiating each of the N amplitude modulated and phase-modulated optical signals via a diffractive block;
receiving each of the N radiated signals by an associated one of N receivers of the diffractive block, wherein diffractions provided by diffractive block represents a square circulant matrix;
modulating a phase of each of the second N optical signals received by the N receivers of the diffractive block using N second phase modulators; and
modulating an amplitude of each of the N second phase-modulated signals using N second amplitude modulators, wherein an amount of modulations selected to be performed by the N second amplitude modulations and the N second phase modulations represent values of a second matrix by which the circulant matrix is multiplied.

13. The method of claim 12 further comprising:
receiving a light emitted by a coherent source of light; and
delivering the received light to the N first optical amplitude modulators of the first sublayer of the first layer of the neural network.

14. The method of claim 13 further comprising:
setting values of each of the second N modulated signals that are below a threshold value to zero by a non-linear optical component.

15. The method of claim 14 wherein the first N amplitude modulators, the first N phase modulators, the diffractive block, the second N phase modulators, and the second N amplitude modulators form a first optical transceiver of sublayer i of layer j of the neural network, the method further comprising:
cascading the first transceiver with a second optical transceiver associated with the sublayer (i+1) of the layer j of the neural network.

16. The method of claim 15 further comprising:
converting an optical signal supplied at each of the N outputs of the non-linear optical component to an electrical signal.

17. A method of forming an opto-electronic neural network comprising a plurality of N-element layers each comprising a plurality of N-element sublayers, the method comprising:
modulating, via N first amplitude modulators, an amplitude of each of N optical signals received from a power splitter using a first associated electrical signal;
modulating, via N first phase modulators, a phase of each of the N amplitude modulated optical signals using a second associated electrical signal;
modulating an amplitude of each of N first optical signals S^{k}_{i,j} received from an associated one of the N first phase modulators, by N first optical amplitude modulators wherein k is an index representing the element number ranging from 1 to N, i represents a sublayer number, and j represents a layer number of the optical neural network;
modulating a phase of each of the N first amplitude modulated optical signals by first N phase modulators, wherein an amount of modulations selected for the first N amplitude modulations and the first N phase modulations represent values of a first matrix by which the optical signal matrix S^{k}_{i,j} is multiplied;
radiating each of the N amplitude modulated and phase-modulated optical signals via a diffractive block;
receiving each of the N radiated signals by an associated one N receivers of the diffraction block, wherein diffractions provided by the diffractive block represents a square circulant matrix;
modulating a phase of each of the second N optical signals received by the N receivers of the diffractive block using N second phase modulators; and
modulating an amplitude of each of the N second phase-modulated signals using N second amplitude modulators, wherein an amount of modulations selected to be performed by the N second amplitude modulations and the N second phase modulations represent values of a second matrix by which the circulant matrix is multiplied.

18. The method of claim 17 further comprising:
converting, using an optical local oscillator signal, an output signal of each of the N second optical amplitude modulators to an I signal and a Q signal;
converting each of the N I signals to a corresponding electrical signal; and
converting each of the N Q signals to a corresponding electrical signal.

19. The method of claim 18 further comprising:
generating signals U^{k}_{i,j} and V^{k}_{i,j} representative of magnitudes and phase of the signals I^{k}_{i,j} and Q^{k}_{i,j}.

20. The method of claim 19 further comprising:
amplifying each of the U^{k}_{i,j} signals; and
amplifying each of the V^{k}_{i,j} signals.

21. The method of claim 20 comprising:
closing N first switches and N second switches in order to supply the amplified U^{k}_{i,j} signals and V^{k}_{i,j} signals as output signals if sublayer i is not the last sublayer of layer j;
closing N third switches and N fourth switches in order to cause signal U^{k}_{i,j} to be added to signal U^{k}_{i-1,j} if sublayer i is the last sublayer of layer j; and
setting a result of adding U^{k}_{i,j} to V^{k}_{i-1,j} to zero if the result is below a threshold value.

22. The method of claim 21 wherein the first N amplitude modulators, the first N phase modulators, the diffractive block, the second N phase modulators, and the second N amplitude modulators form a first optical transceiver of sublayer i layer j of the neural network, the method further comprising:
cascading the first transceiver with a second optical transceiver associated with the sublayer (i+1) of the layer j of the neural network.

23. The optical neural network of claim 1 wherein the optical neural network is trained to acquire images of objects and classify the objects.

24. The optical neural network of claim 1 wherein the optical neural network is trained to operate as a vision system of an autonomous driving vehicle.

25. The optical neural network of claim 1 wherein the vision system is a distributed vision system.

26. The optical neural network of claim 1 wherein the optical neural network is trained to operate as an artificial intelligence accelerator.

27. The optical neural network of claim 26 wherein the artificial intelligence accelerator is disposed in a data center.

28. The optical neural network of claim 26 wherein the artificial intelligence accelerator is disposed in a personal computer.
